(19) United States
(12) Patent Application Publication
(10) Pub. No.: US 2005/0274247 A1
(43) Pub. Date: Dec. 15, 2005

(54) Stripper apparatus and methods for rotary dies

(76) Inventors: Sean Talkington, South Bend, IN (US); Loren Arteberry, Buchanan, MI (US); Mark Leib, Bristol, IN (US); Mark Bontrager, Mishawaka, IN (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 11/151,949

(22) Filed: Jun. 14, 2005

Related U.S. Application Data
(60) Provisional application No. 60/579,274, filed on Jun. 14, 2004.

(51) Int. Cl. B26D 7/06

(52) U.S. Cl. 83/469

(57) ABSTRACT

A rotary die cutting apparatus and method for removing scrap material from work pieces such as plastic or paperboard blanks. One of the dies of a pair of rotary cutting dies is provided with gripper elements that extend over at least a portion of the area of the die corresponding to the areas over which the scrap portions are generated. The gripper elements pierce, partially or completely, the scrap portions generated by the cutting operation of the dies. A stripping knife extends across the die carrying the scrap portions at a height above the gripper elements that provides clearance between the gripper elements and the stripping knife but contacts the scrap portions retained on the gripper elements.

This application claims the benefit of U.S. Provisional Application No. 60/579,274, filed Jun. 14, 2004, which is hereby incorporated by reference.

### FIELD OF THE INVENTION

The present invention relates generally to the field of rotary die cutting devices, and particularly to rotary die cutting machines used in high speed rotary cutting of a moving sheet or web of paper, paperboard, plastics and composite materials.

### BACKGROUND OF THE INVENTION

As one example, rotary die cutting machines are used for the high speed mass production of paperboard carton blanks that are subsequently folded into the shape of carton or box containers. In rotary die cutting, the cutting operations can occur by either of two methods, the first being referred to in the trade as rotary pressure (“RP”) cutting and the second as the “crush cut” method. In the rotary pressure cutting method, the paperboard material from which the carton blanks are generated is advanced at high speed between two rotary die cutting cylinders. The cylinders are provided with cutting elements on them which cooperate to form cutting dies to cut the desired shape of the carton blank as the material advances between the cylinders. The cylinders rotate at the same speed so as to maintain registration of the co-acting cutting surfaces. Each rotation of the cylinders generates a discrete series of one or more cartons depending upon the size of the cartons, diameters of the cylinders, etc. In the crush cut method, one of the cylinders, the cutting cylinder, is provided with knife blades that perform the cutting operation and the other cylinder, known as the anvil cylinder, provides a smooth surface against which the knife blades operate.

In both the above described processes there is necessarily generated a certain amount of scrap material. This material needs to be separated from the carton blanks and removed from the dies as each revolution of the cylinders generates a new series of carton blanks. There are various ways in which the scrap removal process is performed. In one method, the scrap material is initially retained on one of the die cylinders by stripping pins that hold the scrap pieces onto that cylinder as the carton blanks are advanced away. Thereafter, the scrap pieces are removed from the die cylinder by a stripping comb. Alternatively, scrap removal is accomplished separately from the cutting operation. In this method, the carton blank and scrap pieces are retained as contiguous pieces by being left uncut during the cutting operation. The attached pieces are then carried to a stripping station. At the stripping station, the scrap material is removed from the carton blank by piercing the scrap portions with stripping pins carried on a rotating cylinder. As in the previous method, the scrap pieces are retained on the pins by the rotating cylinder until they are stripped off the pins by a stripping comb. A yet further alternative system employs a stripping station which removes the scrap pieces by rotatably registering male elements to “punch” the scrap from the moving web of pre-cut products.

All of the above described methods of scrap removal add to the cost of rotary die cutting and require time and adjustments to optimize their operation in a coordinated fashion with the die cutting operation. For example, the location and number of stripping pins varies for each die and their installation can involve a certain amount of trial and error. Further, in some methods, the stripping pins are individually mounted to the die with a screw threaded base which mounts within complementary threaded mounting holes tapped into the portions of the die where the scrap material is generated. In addition, for each stripping pin a corresponding registration hole must be drilled or otherwise formed in the opposing die. These holes are located to register with the stripping pins.

Thus, there remains the need for further improvement in this field. Various embodiments of the present invention do this in novel and unobvious ways.

### SUMMARY OF THE INVENTION

One aspect pertains to method and apparatus in retention and stripping of scrap portions of a web cut by rotary dies.

Another aspect concerns stripping pins which are releasably captured between a removable die plate and the corresponding mandrel or cylinder.

In yet another aspect a stripping pin projects from a lower rotary die. A distal tip of the stripping pin is received within a channel of an upper rotary die as the scrap portion is generated. The scrap portion is retained between walls surrounding the channel and a surface of the lower die as the tip penetrates into the scrap portion. In some embodiments, the channel is oval-shaped with the long direction of the oval being parallel to the direction of cylinder rotation.

Another aspect relates to a stripping pin which is loosely retained in an underside cavity of a removable die plate. If a first pin wears out during operation during the die cutting apparatus, the first pin can be removed with little or no damage to the die plate and replaced with a second pin.

Yet another aspect concerns a separable stripping pin which comprises a projection of a first, smaller diameter extending from a non-threaded base of a second, larger diameter.

Another aspect relates to fabrication of a removable die plate having a plurality of stripping pins attached thereto by an adhesive.

Further forms, objects, features, aspects, benefits, advantages, and embodiments of the present invention will become apparent from the detailed description and drawings provided herewith.

### DESCRIPTION OF THE DRAWINGS

FIG. 1 is a side and top perspective view of a rotary die cutting apparatus according to one embodiment of the present invention.

FIG. 2 is an enlarged cross sectional side view of the apparatus of FIG. 1.

FIG. 3 is a scaled, cross sectional view of a portion of a rotary die cutting apparatus according to one embodiment of the present invention.

FIG. 4 is top view of the apparatus of FIG. 3.

FIG. 5 is a complete, rotated top view of FIG. 4.

FIG. 6 is a top, plan view of a section of sheet material which includes a plurality of stripper pins according to one embodiment of the present invention.

FIG. 7 is a top, plan view of a lower die plate according to one embodiment of the present invention.

FIG. 8 is a bottom plan view of the opposite side of the apparatus of FIG. 7.

FIG. 9 is a close-up of a portion of the apparatus of FIG. 7.

FIG. 10 is a top, plan view of an upper die plate according to one embodiment of the present invention.

FIG. 11 is an enlarged view of a portion of the apparatus of FIG. 10.

FIG. 12 is a scaled, cross sectional view of a portion of a lower die according to one embodiment of the present invention.

FIG. 13 is a top, plan view of the apparatus of FIG. 12.

FIG. 14 is a side view of the apparatus of FIG. 12.

### DESCRIPTION OF THE PREFERRED EMBODIMENT

This application incorporates by reference U.S. Pat. No. 6,681,666, METHOD AND APPARATUS FOR SCRAP REMOVAL FROM ROTARY DIES, issued Jan. 27, 2004.

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

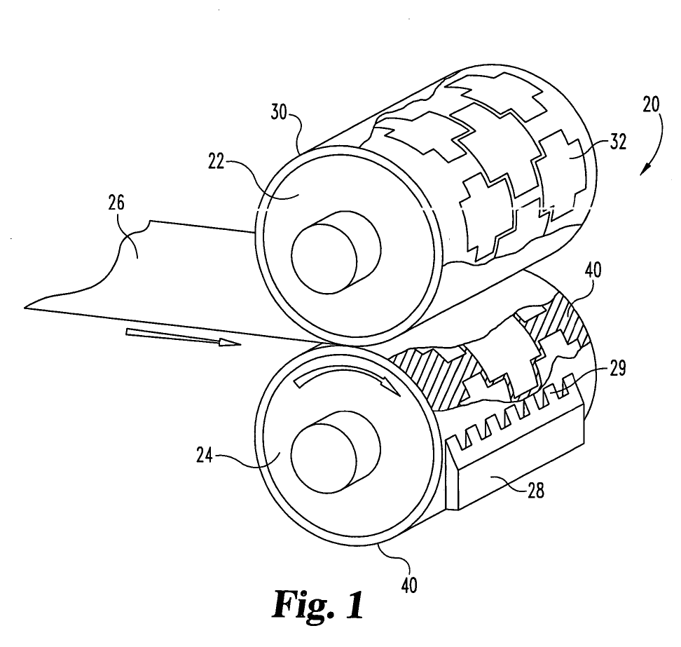

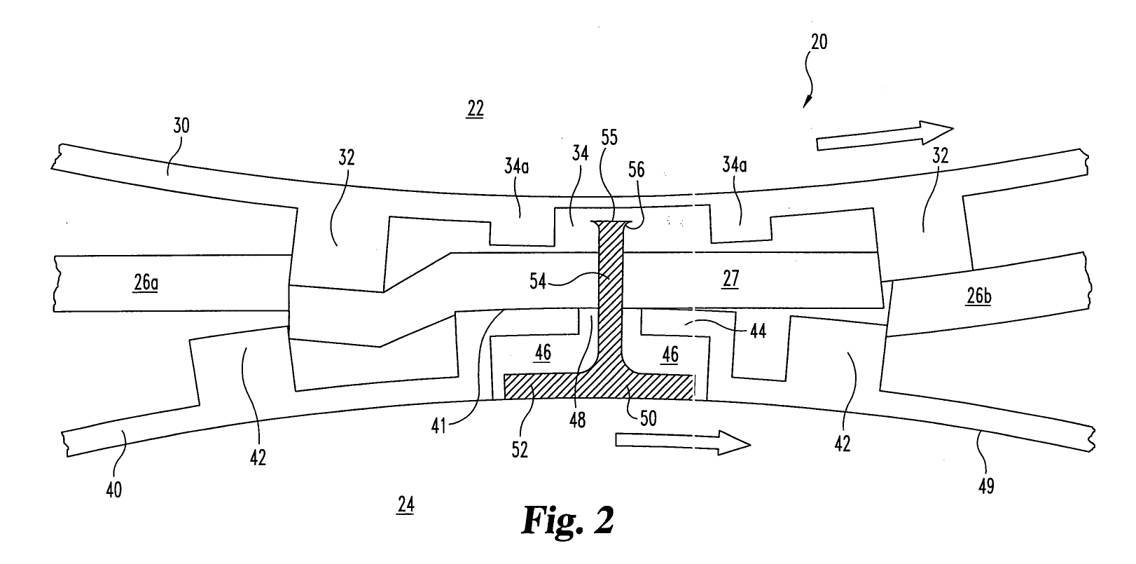

Referring to FIGS. 1 and 2, there is shown a rotary die cutting apparatus 20 of a rotary pressure cutting type according to one embodiment of the present invention. The apparatus 20 comprises a pair of upper and lower rotary dieplates 30 and 40, respectively, for cutting blank portions 26a and 26b and scrap portions 27 from web 26 passing between the dies. The upper and lower dieplates 30 and 40 are removably mounted to mandrels or carrier cylinders 22 and 24, respectively. Although the dies and carrier cylinders are shown as separate elements, it is understood that in some embodiments die plates 30 and 40 can alternatively be integrally formed with their respective carrier cylinders 22 and 24. In one embodiment, die plates 30 and 40 are chemically etched from a sheet of spring steel or stainless steel material, although die plates made of different material, and fabricated by other methods can be used. Separable stripping pins or gripping elements 50 are detachably attached to the lower dieplate 40; however, in other embodiments the stripping pins 50 may be detachably attached to the upper dieplate 30.

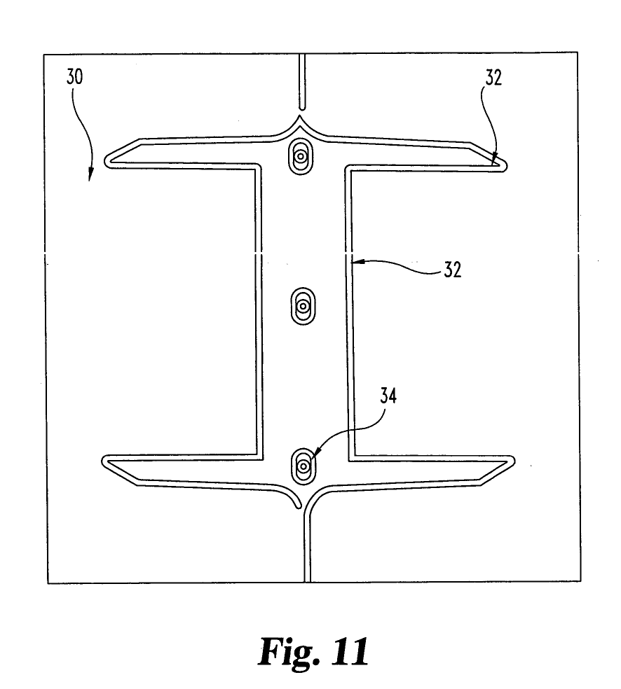

Referring again to FIGS. 1 and 2, upper die 30 includes a plurality of the cutting elements 32 and one or more receiving channels 34 in the areas of the upper die 30 where scrap portions 27 are generated by the cutting operation. Each of the cutting elements 32 surrounds one or more receiving channels 34. Optionally, the receiving channels 34 have an oval shape; however, in other embodiments the receiving channels 34 can have another shape such as, rectangular or circular, to name a few. The receiving channels 34 can be integrally formed with the upper die 30, or alternatively may be separately formed from the die 30 and mounted thereto by bolts or other suitable fastening means. The receiving channels 34 are located in an area of the die 30 that is to receive a scrap portion 27. One purpose of the receiving channels 34 is to provide a surface against which the scrap portions 27 may bear and thereby be forced into engagement with stripper pins 50. Receiving channel 34 is defined by fore and aft peripheral walls 34a. In some embodiments the fore and aft walls 34a are linked in an oval shape, as best seen in FIG. 11. In some embodiments, receiving channel 34 defines a hole through the thickness of upper die 30. However, in other embodiments, the receiving channel 34 is a blind (non-through) channel.

As shown in FIG. 2, the lower die plate 40 includes a plurality of cutting elements 42 arranged to cut a desired shape of blank portions 26a and 26b and scrap portions 27. The cutting elements 42 substantially surround one or more pockets or locating lands 44. The locating land 44 is configured to form a relief cavity or counterbore 46. In this form, the locating land 44 has a substantially circular shape; however, in other embodiments the locating land 44 may be shaped differently. Locating land 44 includes an outermost surface 41. In one embodiment, the outermost surface 41 is located at an elevation similar to an elevation of the cutting elements 42. In other embodiments, the outermost surface 41 is located at an elevation different than an elevation of the cutting elements 42. Locating land 44 also defines a through hole 48. As shown, the hole 48 is located in the center of the locating lands 44. Hole 48 is preferably larger than the diameter of the projection 54 of the stripping pin 50 so that the projection 54 is loose within the hole 48. In other embodiments, the hole 48 is sized to form a light press fit with the projection 54 of the stripping pin 50.

Lower die 40 includes an underside 49. The underside 49 defines a relief cavity or counterbore 46 which is approximately centered within a corresponding locating land 44. As shown, relief cavity 46 has a shape similar to the shape of a base 52 of the stripping pin 50 as described below. In other forms, the relief cavity 46 and the base 52 may each have a different shape.

Web 26 is formed from various workpiece materials, such as paperboard or plastic. The blank portions 26a and 26b are generated by cutting the moving web 26 between co-acting edges of cutting elements 32 and 42 located on the upper and lower dies 30 and 40, respectively, as the cylinders 22 and 24 are rotated in synchronicity in opposite directions of rotation by a suitable drive mechanism (not shown). Separable stripping pins or gripping elements 50 are captured by the lower die 40 in those areas where scrap portions 27 are generated by the cutting process. The upper die 30 is provided with receiving channels 34 that register with each of the pins 50 as the pins 50 reach the cutting position of the upper and lower dies 30 and 40. Additionally, the receiving channels 34 provide a surface against which the scrap portions 27 may rest against and thereby be forced into engagement with the pins 50. In other embodiments, the stripping pins are captured by the upper die and the lower die is provided with receiving channels that register with each of the pins as the pins reach the cutting position of the upper and lower dies.

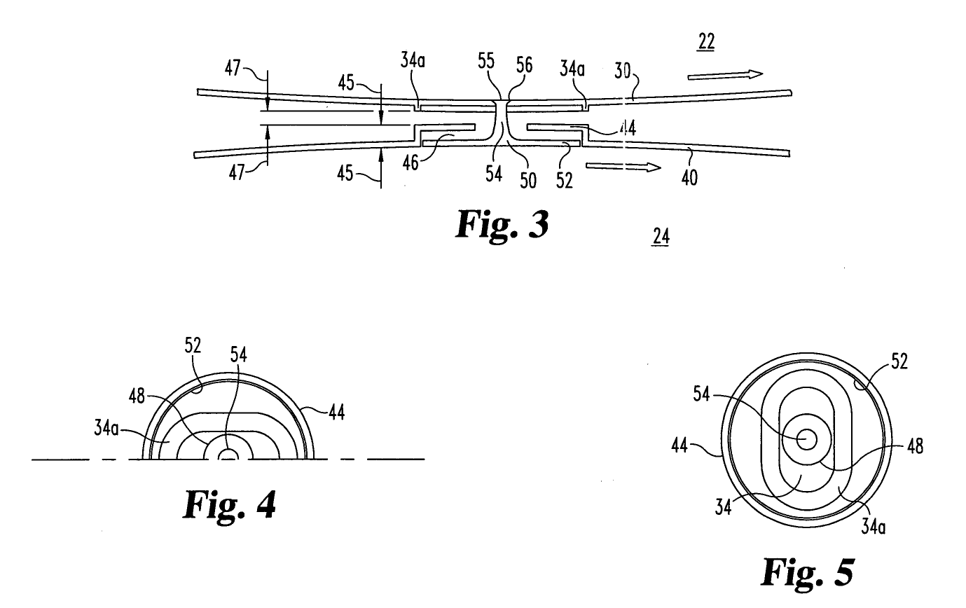

FIGS. 2 and 3 show details of stripper pins 50 in cross section to reveal its shape. The stripping pins or gripping elements 50 are preferably formed with any of several conventional metal removal techniques such as electrical discharge machining, photo-etching, or chemical etching techniques. The stripping pins 50 can be made of various metals, such as steel, stainless steel, aluminum, or any other metal. Optionally, the stripping pins 50 are made with other methods and materials. Example materials for the stripping pins 50 include plastics, ceramics, or composite materials such as fiberglass reinforced materials. Additionally, an example method for fabricating the stripping pins 50 includes injection molding material into a die in the shape of the stripping pins 50.

As shown in FIG. 2, the stripper pin 50 includes a base 52. In this embodiment, the base 52 is a circular shape; however, in other embodiments the base 52 may be shaped differently such as rectangular, triangular, or elliptical to name a few. The stripper pin 50 also includes a projection 54 extending from the base 52. The projection 54 includes a top surface 55 at the distal end. The projection 54 has the general shape of a cylinder except that the projection 54 includes the barbed tip 56 which gives the projection 54 a cylindrical shape with a flared end tip. In other embodiments, the projection 54 has the general shape of a truncated cone except that the upper portion is modified to incorporate an undercut or reverse taper proximate to tip 56 which gives it a sort of mushroom shaped appearance. Yet in other embodiments, the projection 54 can be shaped differently such as rectangular, triangular, or elliptical to name a few. One purpose of the undercut or barbed tip 56 in some embodiments is to provide for increased gripping force on the scrap portion 27. Beneficially, the barbed tip 56 assists the projection 54 to retain the scrap portion 27 while the lower rotary die 40 and mandrel or carrier cylinder 24 rotate.

The size of the stripper pins 50 can vary with the thickness and type of material for web 26 being used to generate the blanks 26a and 26b. In some embodiments, the base 52 has a thickness of from about 0.01″ to about 0.02″. Generally, it is anticipated that the diameter of the projection 54 of the stripper pins 50 will be in a range of 0.01″ to about 0.1″ and the overall height will range from about 0.020″ to about 0.060″. Base 52 has a diameter larger than hole 48 of die plate 40 and preferably smaller than the internal diameter of cavity 46. Therefore, securement of die plate 40 to mandrel 24 (such as by magnetic or other means) also releasably captures pins 50 in their corresponding cavities 46. In those embodiments in which die plate 40 is releasably attached to mandrel 24, the pins 50 can be replaced by removal of the die plate 40 and removal of the separable pins 50.

As shown in FIG. 2, a section of the paper board or plastic web 26 is shown passing between upper and lower mandrels 22 and 24. The feedstock or blank portion 26a of the web 26 has passed by the upper and lower cutting elements 32 and 42. A blank portion 26b is shown exiting from between a pair of cutting elements 32 and 42. A scrap portion 27 is located between upstream and downstream cutting elements 32 and 42, and is shown pierced by a projection 54 of a stripper pin 50. Stripper pin 50 is preferably a separable pin which is releasably captured within a relief cavity or counterbore 46 of lower dieplate 40. Preferably, the height or thickness of the base 52 is less than the height of the cavity 46 so that pin 50 fits loosely within cavity 46. Projection 54 extends through the hole 48 which has been milled or formed from dieplate 40. Preferably, the barbed tip 56 at the distal most end of projection 54 is spaced higher than the outermost surface 41 of locating land 44. In some embodiments, outermost surface 41 of locating land 44 is roughly the same elevation as the cutting elements 42. In yet other embodiments, outermost surface 41 substantially represents the original, unmilled thickness of the sheet material from which lower dieplate 40 was fabricated.

In one form, pin 50 is adapted and configured such that the length of projection 54 extends to a location within a receiving channel 34 defined by fore and aft peripheral walls 34a of upper die 30 as shown in FIG. 2. In this form, the projection 54 has pierced both the top and bottom surfaces of scrap portion 27. In other forms, the pin 50 is adapted and configured such that the length of projection 54 extends to a location near receiving channel 34; however, the projection 54 pierces the bottom surface of scrap portion 27 but the projection 54 does not enter the receiving channel 34.

FIG. 3 is an enlarged sectional view of apparatus 20 similar to that of FIG. 2 but without blank portions 26a, 26b, and scrap portion 27 being shown. FIG. 3 is a scaled drawing of one embodiment. As best seen in FIGS. 2 and 3, the stripping pins 50 are preferably provided with a barbed tip 56 adapted to pierce the scrap portions 27 and thereby retain the scrap portions 27 as the blank portions 26a and 26b advance through the space between the dies 30 and 40. In addition, the pins 20 can include a barb or undercut to facilitate retention of the scrap portions 27 thereon. Preferably, the barbed tip 56 of pin 50 pierces through the thickness of the scrap portion 27. In other embodiments, the tip 56 of the stripping pin 50 pierces through one side of the scrap portion 27 but not the other side of the scrap portion 27. In other embodiments, the projection 54 does not include a barbed tip 56.

As shown in FIG. 1, the rotary die cutting apparatus 20 includes a stripping comb 28 attached to the lower rotary die 40. In another embodiment wherein the pin 50 is attached to the upper rotary die 30, the stripping comb 28 is attached to the upper rotary die 30. Yet in other embodiments, the stripping comb 28 is placed adjacent the appropriate rotary die to remove the scrap portions 27 from the stripper pins 50. The stripping comb 28 includes a plurality of teeth 29 spaced along a contact edge of the stripping comb 28. As shown, the teeth 29 are rectangular in shape; however, in other embodiments the teeth 29 may have a different shape such as triangular, curvilinear, or trapezoidal to name a few.

Referring to FIG. 2, it can be seen that the tips 56 of the stripping pins 50 preferably extend locally above the outermost surface of the lower dieplate 40. As shown in FIG. 1, as the lower cylinder 24 rotates, scrap portions 27 retained on the lower die 40 by the stripping pins 50 come into contact with the teeth 29 of stripping comb 28. The pins 50 do not contact the teeth 29 of the stripping comb 28 because the projections 54 of the pins 50 pass through the spaces between the teeth 29 of the comb 28. As the lower cylinder 24 continues to rotate, the scrap portions 27 slide or continue over the teeth 29 and the scrap portions 27 are removed from the pins 50.

Mandrel 24 and lower die plate 40 preferably releasably capture stripper pins 50 that serve to grip, either with or without piercing substantially through, the scrap portions 27. In other embodiments, mandrel 22 and upper die plate 30 releasably capture stripper pins 50. As best seen in FIGS. 4 and 5, locating land 44 and through hole 48 are located on lower die 40 such that projection 54 projects within receiving channel 34 during rotation of mandrels 22 and 24. In these embodiments, receiving channel 34 is oval shaped and surrounded by an oval-shaped peripheral wall 34a. As shown in FIGS. 3 and 4, the long dimension of the oval receiving channel 34 is preferably parallel to the direction of rotation. In other forms, the receiving channel 34 can be other shapes as mentioned above.

While the invention is described in connection with a rotary pressure cutting method where there are cutting elements on both the upper and lower dies, the invention is also useful with “crush cut” methods which employ cutting elements on only one of the dies (e.g., the “carrier” die) and co-act against an anvil cylinder.

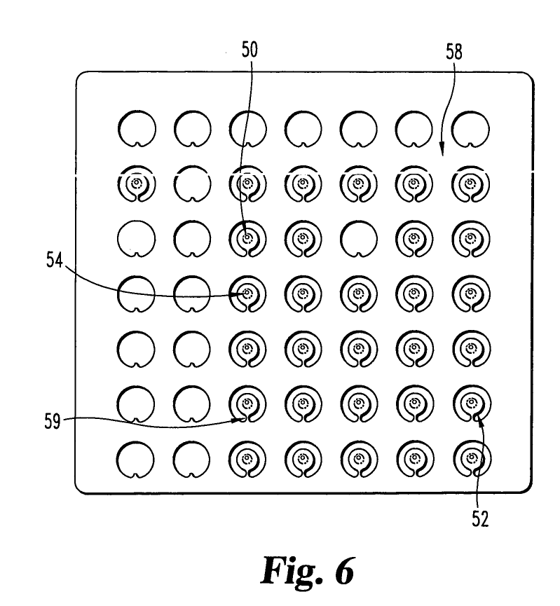

FIGS. 6, 7, 8, 9, 10, and 11 are plan views of various aspects according to a particular embodiment. FIGS. 6, 7, 8, 9, 10, and 11 are generated from photographs.

FIG. 6 shows a plurality of stripper pins 50 prior to complete fabrication of the stripping pin according to one embodiment. In this embodiment, a plurality of stripping pins 50 are shown chemically milled from a portion of sheet material 50. As mentioned previously, the stripping pins 50 may be fabricated in other manners. For example, the stripping pins 50 may be formed from sheet material 50 with other metal removal techniques such as electrical discharge machining or photo-etching techniques. The top view shown in FIG. 6 shows the projection 54 extending from a circular base 52. In this embodiment, the chem milling procedure is controlled such that a retention member 59 is retained, which secures the semi-finished pins shown in FIG. 6 to the sheet material 58. Each pin 50 is further processed to a final stage by grinding away the retention member 59 and thereby generating a loose, separate pin 50.

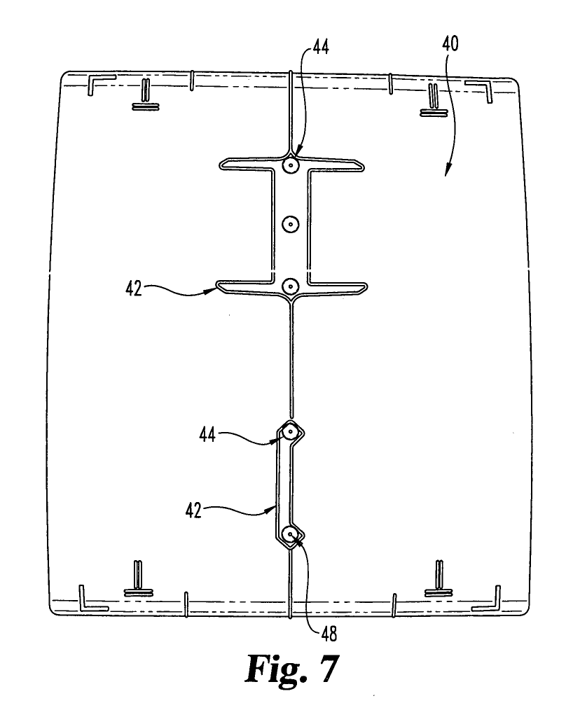

FIGS. 7, 8, and 9 depict views of an unwrapped lower die plate 40 according to one embodiment of the present invention. FIG. 7 shows the outer side of die plate 40. Die plate 40 includes a plurality of cutting elements 42 arranged in a pattern to cut a desired shape of blank portions 26a and 26b. The cutting elements 42 generally surround one or more locating lands 44. Die plate 40 is prepared from a portion of sheet material having an initial thickness. In some embodiments, the pattern of cutting elements 42 and locating lands 44 (as well as other surface features shown in FIG. 7) are covered with a coating that resists chemical milling in a desired pattern. In these embodiments, the outermost surface 41 of locating lands 44 are roughly representative of the original surface and original thickness of the sheet material. However, in other embodiments, the locating lands 44 have an outermost surface 41 which is at a different elevation than the outmost surface of cutting elements 42. Although not shown, lower die plate 40 is wrapped around mandrel 24 for use.

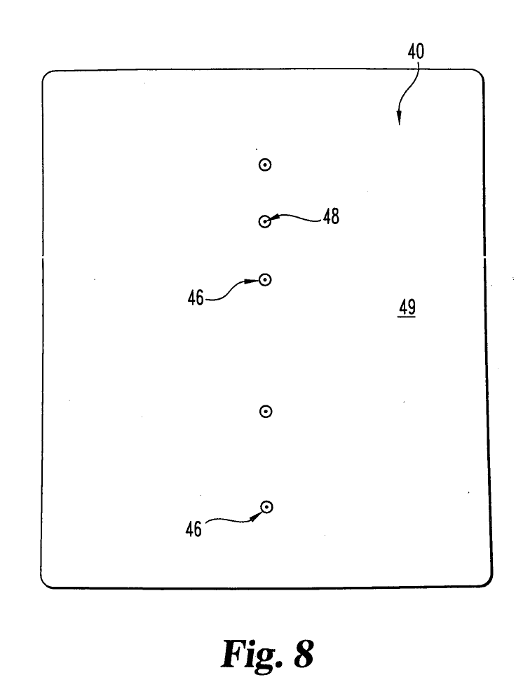

Referring to FIG. 8, the reverse side or underside 49 of die 40 includes a relief cavity or counterbore 46 which is roughly centered within a corresponding locating land 44. FIGS. 7 and 8 show five locating lands 44 and five relief cavities 46, respectively. Preferably, relief cavity 46 has a shape which is complementary to the shape of base 52 of pin 50. In a preferred embodiment, both cavity 46 and base 52 are circular. However, in other embodiments different shapes such as square, triangular, oval, or other shapes, are used. Preferably, the inner diameter and inner height of relief cavity 46 are greater than the outer diameter and outer height of base 52, so that a pin 50 is loosely received within the cavity 46.

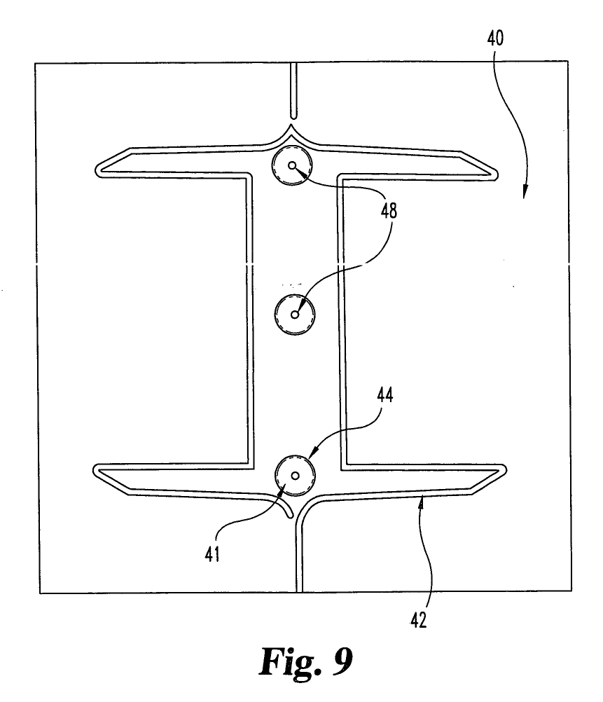

FIG. 9 is a close-up of a portion of lower die 40. In this embodiment, locating lands 44 are generally circular. A through hole 48 is fabricated preferably through the center of each locating land 44. Hole 48 is preferably larger than the diameter of the projection 54 of the pin 50, so that the projection 54 is loose within the corresponding hole 48. In other forms, the projection 54 of the pin 50 is a light press fit in the hole 48. In some embodiments, individual, separate pins 50 are placed within the corresponding cavities 46 of a lower die 40 and held in place by an adhesive to prevent the pin 50 from falling out as the lower die plate 40 is wrapped around the lower mandrel 24.

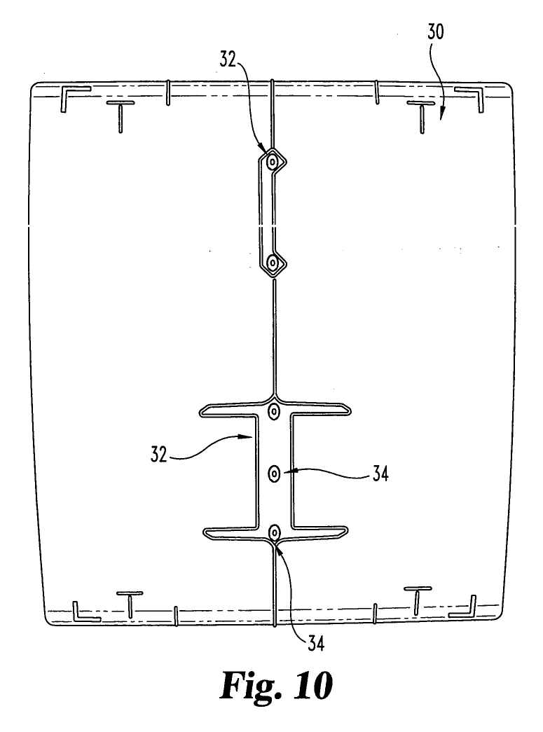

FIGS. 10 and 11 show plan views of the outer surface of an unwrapped, upper die plate 30. Upper die plate 30 includes cutting elements 32 which are shaped and located in a manner to correspond with cutting elements 42 of lower die plate 40. Together cutting elements 32 and 42 provide cutting action of web 26 passed therebetween. Each cutting element 32 surrounds one or more receiving channels 34. The receiving channels 34 are located within the area of die plate 30 which will define a scrap portion 27 of the web 26. As best seen in FIG. 11, in a preferred embodiment the receiving channel 34 has an oblong or oval shape, with the long direction being parallel to the direction of rotation of the assembled die. In another form, the receiving channel 34 may be shaped differently, as mentioned above.

As best seen in both FIGS. 2 and 3, the peripheral walls 34a which surround receiving channel 34 project downward such that tip 56 of a corresponding pin 50 extends past the outermost surface of the peripheral walls 34a and into receiving channel 34. Preferably, the scrap portion 27 is trapped between the outermost surface 41 of a locating land 44 and the outermost surface of the corresponding peripheral wall 34a. By trapping the scrap portion 27 therebetween, the material is prevented from simply deforming when it comes into contact projection 54, and instead tip 56 is forced to pierce into the scrap portion 27. It is to be appreciated that the distance between the outermost surface or bearing surfaces of receiving channels 34 and the top surfaces 55 of the stripper pins 50 determine the distance to which the stripper pins 50 pierce into the scrap portions 27. In some embodiments, the pin has a total height, from the bottom of the base to the top of the tip, of 0.06″ to 0.07″. In some embodiments, plate 40 has an initial thickness of 0.035″. In the described embodiment, the barbed tip 56 protrudes nominally 0.035″ above the outermost surface of the locating land 44. In that embodiment, the minimum clearance between the assembled upper die plate 30 and the assembled lower die plate 40 is nominally 0.002″ greater than the caliper thickness of the web 26 being cut. Although specific dimensions have been shown and described, the present invention is not so limited and contemplates embodiments having other dimensional features.

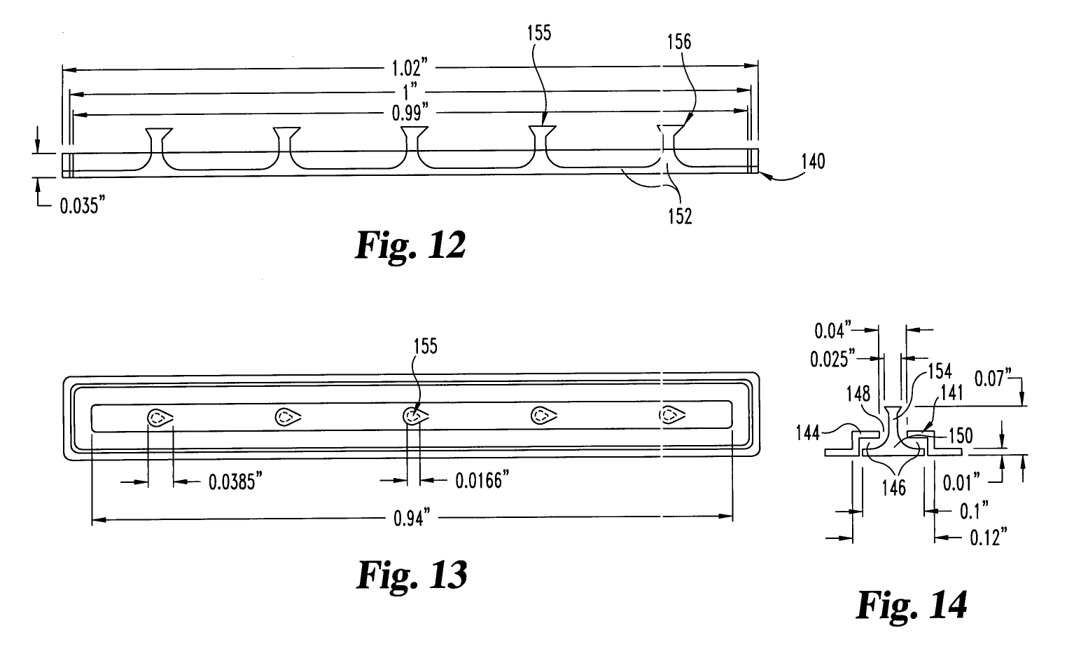

FIGS. 12, 13, and 14 show various aspects of a particular embodiment. FIGS. 12, 13, and 14 are scaled drawings with dimensions. The use of a hundred-series prefix (NXX) in front of an element number (XX) indicates an element that is the same as the non-prefixed element number, except for those changes shown or described hereafter. As shown in FIG. 12, the lower die plate 140 includes a locating land 144. Locating land 144 is similar to locating land 44 as previously discussed. In this form, locating land 144 surrounds five stripping pins 150. Stripping pins 150 are similar to stripping pins 50 as previously discussed. In other embodiments, locating land 144 may surround any number of stripping pins 150. Yet in other embodiments, the locating land 144 is configured to surround stripping pins 150, stripping pins 50, and/or any other stripping pin.

The locating land 144 is configured to form a relief cavity or counterbore 146. As shown, the locating land 144 has a substantially rectangular shape; however, in other embodiments the locating land 144 may be shaped differently. Locating land 144 includes an outermost surface 141. Locating land 144 also defines a through hole 148. As shown, the hole 148 is a rectangular shape; however, in other embodiments the hole 148 may be shaped differently. Hole 148 preferably surrounds all of the diameters of the projections 154 of the stripping pins 150 located within the hole 148. In this form, hole 148 is sized so that the projections 154 are loose within the hole 148. In other forms, hole 148 is sized so that the projections 154 are tightly retained within the hole 148.

As mentioned previously, stripping pins 150 are similar to stripping pins 50. Stripping pins 150 include a continuous base 152. In this embodiment, the base 152 is a rectangular shape; however, in other embodiments the base 152 may be shaped differently. In one form, the stripping pins 150 and the continuous base 152 are separable from the lower die plate 140. In this form, multiple stripping pins formed with continuous base 152 allows any number of stripping pins to be attached to and detached from lower die plate 140 as one common piece. Each of the stripping pins 150 also includes a projection 154 extending from the continuous base 152. In other forms, the base 152 may be separate individual supports for each of the projections 154. The projection 154 includes a top surface 155 at the distal end. The projection 154 has the general cross sectional shape of a tear drop. The projection 154 includes a barbed tip 156 having a tear drop shape. In other embodiments, the projection 154 and/or the barbed tip 156 can be shaped differently or the projection 154 and barbed tip 156 can be shaped different from each other.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A rotary die cutting apparatus for cutting a moving web of material into blanks, comprising:
a pair of carrier cylinders;
first and second rotary dies each removably mounted to a different one of said carrier cylinders, at least one of said rotary dies having cutting elements thereon adapted to generate blanks and scrap portions from the moving web of material, at least one of said rotary dies having a plurality of cavities, each cavity including a through hole;
a plurality of stripping pins extending from said at least one of said rotary dies, each of said stripping pins having a base adapted and configured to fit within a different one of said cavities, each of said stripping pins having a projection adapted and configured to pass through the hole of the corresponding cavity, said projection extending from said base;
wherein said stripping pins pierce said scrap portions as said rotary dies rotate.

2. The apparatus of claim 1 wherein said first and second rotary dies have co-acting cutting elements thereon.

3. The apparatus of claim 1 wherein said other of said rotary dies defines a plurality of receiving channels thereon adapted and configured to retain said scrap portions.

4. The apparatus of claim 3 wherein each of said receiving channels has an elongated shape oriented in a direction of rotation of said other of said rotary die.

5. The apparatus of claim 4 wherein each of said receiving channels has a substantially oval shape.

6. The apparatus of claim 3 wherein said stripping pins register with said scrap portions, each of said stripping pins being received within a different one of said receiving channels as said rotary dies rotate.

7. The apparatus of claim 6 wherein each of said receiving channels define a hole for receiving each of said stripping pins.

8. The apparatus of claim 6 wherein each of said receiving channels are non-through.

9. The apparatus of claim 3 wherein each of said cutting elements substantially surround at least one of said receiving channels.

10. The apparatus of claim 1 wherein said base of said stripping pin is loosely retained within said cavity.

11. The apparatus of claim 1 wherein said base of said stripping pin is tightly retained within said cavity.

12. The apparatus of claim 1 wherein said stripping pins pierce through said scrap portions as said rotary dies rotate.

13. The apparatus of claim 1 wherein said stripping pins repeatedly attach to and repeatedly detach from said at least one of said rotary dies.

14. The apparatus of claim 1 wherein said stripping pins are integrally mounted to at said at least one of said rotary dies.

15. The apparatus of claim 1 further comprising a stripping comb having a plurality of teeth for contacting the leading edges of said scrap portions as said scrap portions are stripped away from said stripping pins, said projections pass through the spaces between the plurality of teeth.

16. A die cutting apparatus for cutting a moving web of material into blanks, comprising:
first and second rotary dies, both of said rotary dies having co-acting cutting elements thereon adapted to generate blanks and scrap portions from the moving web of material, said first rotary die defining a plurality of receiving channels thereon adapted and configured to retain said scrap portions;
a plurality of stripping pins repeatedly attachable and repeatedly detachable from said second rotary die,
wherein said stripping pins register with said scrap portions, each of said stripping pin being received within a different one of said receiving channels as said first die rotates past said second die.

17. The apparatus of claim 16 wherein each of said receiving channels has an elongated shape oriented in a direction of rotation of said first rotary die.

18. The apparatus of claim 16 wherein each of said receiving channels has a substantially oval shape.

19. The apparatus of claim 16 wherein said cutting elements of said first rotary die substantially surround at least one of said receiving channels.

20. The apparatus of claim 16 wherein said second rotary die defines a plurality of cavities, each cavity including a through hole; and
each of said stripping pins having a base adapted and configured to fit within a different one of said cavities, each of said stripping pins having a projection adapted and configured to pass through the hole of the corresponding cavity, said projection extending from said base.

21. The apparatus of claim 20 wherein said base of said stripping pin is loosely retained within said cavity.

22. The apparatus of claim 20 wherein said base of said stripping pin is tightly retained within said cavity.

23. The apparatus of claim 16 wherein each of said stripping pins includes a tip, said tip is substantially a barb shape.

24. The apparatus of claim 16 wherein each of said stripping pins have a height in a range of about 0.02 to 0.06 inches.

25. The apparatus of claim 16 further comprising a stripping comb having a plurality of teeth for contacting the leading edges of said scrap portions as said scrap portions are stripped away from said stripping pins, said stripping pins passing through the spaces between the plurality of teeth.

26. A rotary die cutting apparatus for cutting a web of material into blanks, comprising:
a cylinder;
a die plate releasably captured on the surface of said cylinder, said die plate having cutting elements thereon adapted to generate blanks and scrap portions from the web of material, said die plate defining a plurality of underside cavities; and
a plurality of stripping pins each loosely retained in a different one of said underside cavities between said die plate and the surface of said cylinder.

27. The apparatus of claim 26 wherein said first stripping pin removable from said underside cavity and replaceable with a second stripping pin, both of said stripping pins registering with said scrap portions, said both stripping pins piercing said scrap portions.

28. The apparatus of claim 27 further comprising a stripping comb having a plurality of teeth for contacting the leading edges of said scrap portions as said scrap portions are stripped away from said both stripping pins, said both stripping pins passing through the spaces between the plurality of teeth.

29. The apparatus of claim 26 wherein each of said underside cavities includes a through hole, each of said stripping pins having a base adapted and configured to fit within said underside cavity, each of said stripping pins having a projection adapted and configured to pass through the hole of the corresponding cavity, said projection extending from said base.

30. A die cutting apparatus for cutting a moving web of material into blanks, comprising:
first and second rotary dies, both of said rotary dies having co-acting cutting elements thereon adapted to generate blanks and scrap portions from the moving web of material, said first rotary die defining a plurality of cavities, each cavity including a through hole;
a plurality of stripping pins extending from said first rotary die, said plurality of stripping pins having a base adapted and configured to fit within one of said cavities, each of said stripping pins having a projection adapted and configured to pass through the hole of said cavity, said projection extending from said base;
wherein said stripping pins pierce said scrap portions as said rotary dies rotate.

31. The apparatus of claim 30 wherein said second rotary die defines a plurality of receiving channels thereon adapted and configured to retain said scrap portions.

32. The apparatus of claim 31 wherein said stripping pins register with said scrap portions, each of said stripping pins being received within a different one of said receiving channels as said rotary dies rotate.

33. The apparatus of claim 31 wherein said stripping pins register with said scrap portions, said plurality of stripping pins being received within one of said receiving channels as said rotary dies rotate.

34. The apparatus of claim 30 wherein said stripping pins repeatedly attach to and repeatedly detach from said first rotary die.

35. The apparatus of claim 30 wherein each of said stripping pins includes a tip, said tip is substantially a tear drop shape.

36. The apparatus of claim 30 wherein said base is continuous between said plurality of stripping pins.
